(19) United States
(12) Patent Application Publication
(10) Pub. No.: US 2008/0230962 A1
(43) Pub. Date: Sep. 25, 2008

(54) Method of creating high strength expanded thermoformable honeycomb structures with cementitious reinforcement

(75) Inventors: Thomas St. Denis, Rowayton, CT (US); Gabriel M. Karamanis, Stamford, CT (US)

Correspondence Address: Paul D. Greeley;Ohlandt, Greeley, Ruggiero & Perle, L.L.P., One Landmark Square, 10th Floor, Stamford, CT, 06901-2682, US

(73) Assignee: Panterra Engineered Plastics, Inc.

(21) Appl. No.: 11/453,378

(22) Filed: Jun. 15, 2006

Related U.S. Application Data
(60) Provisional application No. 60/690,584, filed on Jun. 15, 2005.

(51) Int. Cl. C04B 33/36; C04B 33/32; C04B 35/64; B29C 39/10; B29C 41/20

(52) U.S. Cl. 264/630; 264/631; 264/69; 264/259

(57) ABSTRACT

A method for producing expanded honeycomb materials with cementitious reinforcement, in a composite structure having significant structural rigidity and strength, reduction in overall weight and ease of installation comprising the steps of: placing an expanded thermoformable honeycomb in a mold or suitable mold; partially or completely filling either or both sides of the honeycomb with cementitious material; vibrating the cementitious material within the structure to eliminate any air pockets or voids; leveling the cementitious material and allowing it to cure at room or elevated temperature; removing the composite structures from the mold.

### CROSS REFERENCE TO RELATED APPLICATION

The present application is claiming priority of U.S. Provisional Application Ser. No. 60/690,584, filed on Jun. 15, 2005.

### BACKGROUND OF THE INVENTION

1. Field of the Invention

The present invention relates to a method of producing expanded thermoformable honeycomb material structures with cementitious reinforcement. In particular, the invention relates to a method for producing such materials that reduces or eliminates the need for rebar or fiber reinforcement.

2. Description of the Prior Art

Processes used to make expanded thermoformable honeycomb materials typically involve placing a thermoformable, thermoplastic polymeric material sheet between mold platens, which are attached to a heated press. The thermoformable, thermoplastic, polymeric material sheet is heated to a specific temperature at which the thermoformable material will adhesively bond to the mold platens by a hot tack adhesion mechanism. The mold platens are then separated, with the thermoformable material adhering to the mold platens, so as to affect an expansion of the cross-section of the thermoformable material.

Typically, the surfaces of the mold platens that are bonded to the thermoplastic material sheet have a number of perforations. The thermoplastic material will adhesively bond to the non-perforated portion of this surface so that when the mold platens are separated apart, a number of cells will be formed within the cross-section of the expanded thermoformable material. Generally, these perforations can have a variety of different geometries and can be arranged in an array of patterns on the surface of the mold platens, thereby creating thermoformable materials having a variety of cross-sectional geometries.

The processes previously referenced produce an expanded thermoformable honeycomb material product that is strong and durable, with a conical closed cell design that creates an internal truss structure which is an important element of its strength. Certain engineering characteristics of the thermoplastic polymers used make them capable of producing high quality, high strength expanded thermoformable honeycomb materials.

Products typically used in reinforcing structures consist of either solid cement, cement reinforced with various aggregates or sand, cement reinforced with rebars, or cement reinforced with short or long inorganic fibers. These products are typically manufactured in molds or forming/curing tools that will accept the cementitious material that has been formulated with aggregate, sand, rebar or fibrous materials, or combinations thereof. The associated problems with these products are high weight, difficulty in handling or installation and cost of the final structure.

Accordingly, there is a need for similar products with all the primary features of strength and durability, but without the additional weight, cost and difficulty of installation.

### SUMMARY OF THE INVENTION

A method for producing a cementitious reinforced expanded honeycomb material, the method comprising: contacting at least one side of the expanded honeycomb material with a semisolid or liquid cementitious material, wherein the cementitious material penetrates at least a first portion of the honeycomb material, thereby forming an integrated honeycomb/cementitious product; vibrating the integrated honeycomb/cementitious product to remove air pockets therefrom and/or level the surface of the cementitious product which is opposite from the interface between the expanded honeycomb material and the cementitious material; and curing the integrated honeycomb/cementitious product, thereby forming the cementitious reinforced expanded honeycomb material.

Alternatively, the method may further comprise: contacting a second surface of the expanded honeycomb product which is opposite to the surface of the expanded honeycomb cementitious reinforced expanded honeycomb material with a second semisolid or liquid cementitious material, wherein the cementitious material penetrates at least a the second surface of the expanded honeycomb material, thereby forming a integrated honeycomb product with first and second layers of cementitious material disposed on opposite surfaces thereof; vibrating the integrated honeycomb product to remove air pockets therefrom and/or level the surface of the cementitious product which is disposed opposite the second portion of the expanded honeycomb material; and curing the integrated honeycomb product with first and second layers of cementitious material disposed on opposite surfaces thereof, thereby forming a multilayer cementitious reinforced expanded honeycomb material.

The thermoformable honeycomb comprises at least one material selected from the group consisting of: high impact polystyrene, polycarbonate, acrylonitrile butadiene styrene, homo- or co-polymer polypropylene, and low or high density polyethylene.

The thermoformable honeycomb further comprises at least one additive selected from the group consisting of: plastic, glass, mineral, carbon, ceramic, boron, wood, aramid, or metal fibers, carbon nanotubes or nanoclays, calcium carbonate, calcium silicate, calcium sulfate, aluminum silicate, alumina trihydrate, glass microspheres, carbon black, solid/liquid or paste pigments, silicon dioxide, flexible polymeric materials such as butadiene, acrylonitrile, carboxyl terminated butadiene styrene, and recycled materials.

The cementitious material comprises at least one additive selected from the group consisting of: plastic, glass, mineral, carbon, ceramic, boron, wood, aramid, or metal fibers, carbon nanotubes or nanoclays, calcium carbonate, calcium silicate, calcium sulfate, aluminum silicate, alumina trihydrate, glass microspheres, carbon black, solid/liquid or paste pigments, silicon dioxide, flexible polymeric materials such as butadiene, acrylonitrile, carboxyl terminated butadiene styrene, and recycled materials.

Other advantages and features of the present invention will be understood by referencing the following specification in conjunction with the related drawings.

### BRIEF DESCRIPTION OF THE DRAWINGS

FIG. 1 shows a cross-section of a mold, honeycomb, and layer of cementitious material according to a first embodiment of the present invention; and

FIG. 2 shows a cross-section of a mold, honeycomb, and layer of cementitious material according to a second embodiment of the present invention.

### DETAILED DESCRIPTION OF THE INVENTION

In the present invention, the raw material sheet from which the expanded honeycomb is formed is carefully selected for its engineered performance characteristics. The raw material sheet should have the appropriate orientation, elongation and melt index characteristics prior to being manufactured into a honeycomb, so that when the composite structure of the present invention is formed by the process described below, the composite structure will have high strength, rigidity and overall structural integrity.

Extruded or molded sheets of thermoplastic material can be used in this process. Examples of raw materials that can be used include, but are not limited to, high impact polystyrene, polycarbonate, acrylonitrile butadiene styrene, homo- or co-polymer polypropylene, low and high density polyethylene, or a host of other thermoplastic materials. These materials can be extruded or molded utilizing co-extrusions, molded layers, alloys, fiber/filler/nano reinforced polymers, recycled materials, or variations and combinations of all of the above. The materials selected can be a heterogeneous mixture, and can be extruded so that the heated thermoformable sheet used to make the honeycomb comprises a plurality of layers. For example, the thermoformable sheet can comprise a pair of outer layers comprising a first material and an inner layer comprising a second material, wherein said inner layer is disposed between said pair of outer layers. Such methods and materials are well known in the art. Such methods are well known in the art.

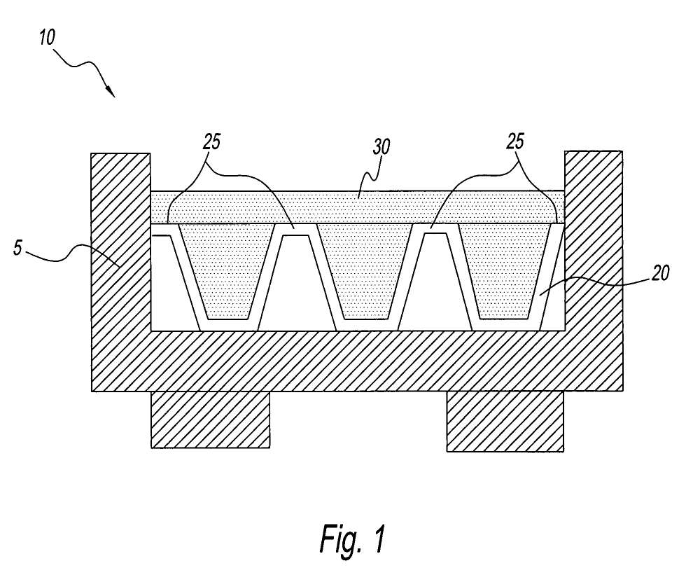

Referring to FIG. 1, a honeycomb 20 and a layer of cementitious material 30 disposed within a mold 5 is shown. Once the expanded honeycomb 20 is formed, it is placed in the mold or suitable mold 5. The mold of the present invention can comprise any material suitable for the below described processes, including but not limited to steel, aluminum, composite epoxy, homo- or co-polymer polypropylene, glass filled homo- or co-polymer polypropylene, low or high density polyethylene, glass filled low or high density polyethylene, acetal, PTFE filled acetal, or combinations thereof.

A layer of cementitious material 30, with or without aggregate or fibrous reinforcement, is introduced into the expanded thermoplastic honeycomb structure 20 fully to fill one side of the honeycomb 20, and extend slightly beyond a plane defined by peaks 25 of honeycomb 20.

After the appropriate amount of cementitious material has been delivered into the honeycomb 20, the mold or forming tool 5 with the honeycomb 20 and layer of cementitious material 30 is vibrated to eliminate any air pockets or voids. The layer of cementitious material 30 is then leveled and cured at room or elevated temperature. After curing, the composite structure, which comprises the honeycomb 20 and layer of cementitious material 30 and is generally referred to by numeral 10, is removed from the mold 5.

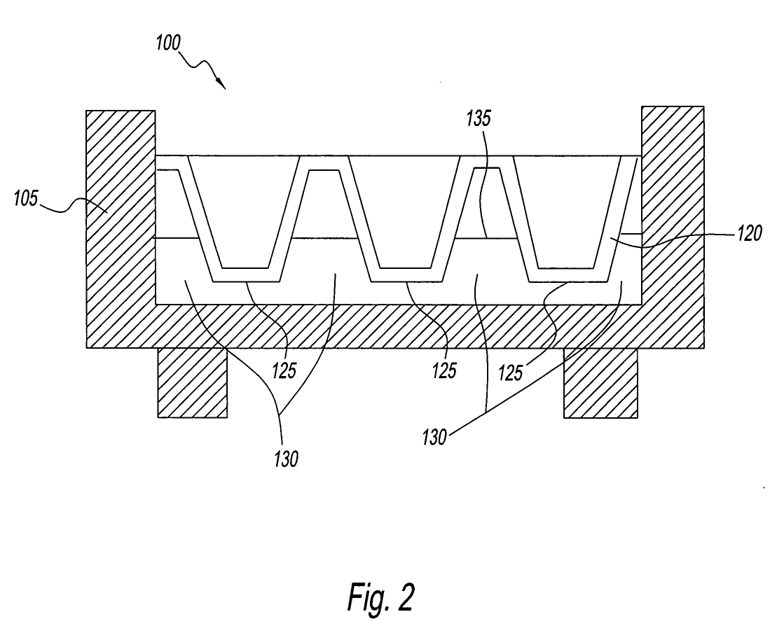

Referring to FIG. 2, a honeycomb 120 and a layer of cementitious material 130 disposed within a mold 105 is shown. In this embodiment, a mold or suitable mold 105 is filled to an appropriate level with a layer of cementitious material 130, with or without aggregate or fibrous reinforcement. A honeycomb 120 is placed in the mold 105 and forced into the layer of cementitious material 130 so that the cementitious material is allowed to partially fill the honeycomb 120 to a preset height 135, and extend slightly beyond a plane defined by peaks 125 of honeycomb 120.

The advantage to partially filling the honeycomb 120 with the layer of cementitious material 130 is that the resulting composite structures 100 are lighter, easier to handle, and use less material, which reduces cost. Alternatively, the honeycomb 120 can be forced into the layer of cementitious material 130 so that the material completely fills honeycomb 120.

After the appropriate amount of cementitious material has been delivered into the honeycomb 120, the mold or forming tool 105 with the honeycomb 120 and layer of cementitious material 130 is vibrated to eliminate any air pockets or voids. The layer of cementitious material 130 is then leveled and cured at room or elevated temperature. After curing, the composite structure, which comprises the honeycomb 120 and layer of cementitious material 130 and is generally referred to by numeral 100, is removed from the mold 105.

In either of the embodiments discussed above, the second side of the honeycomb can be filled by removing the composite structure from the mold, and repeating the above outlined steps for the second side of the honeycomb.

The thermoplastic material used for the honeycomb and the cementitious material can comprise additives or fillers to provide additional strength to the composite structure. For example, the honeycomb or cementitious material can comprise at least one additive selected from the group consisting of: plastic, glass, mineral, carbon, ceramic, boron, wood, aramid, or metal fibers, carbon nanotubes or nanoclays, calcium carbonate, calcium silicate, calcium sulfate, aluminum silicate, alumina trihydrate, glass microspheres, carbon black, solid, liquid, or paste pigments, silicon dioxide, flexible polymeric materials, such as butadiene, acrylonitrile, carboxyl terminated butadiene styrene, and recycled materials.

A significant characteristic of the present invention is the reduction in weight of the composite structure over the prior art where structures formed were very heavy. The weight reduction of the composite structure formed in the present invention can easily be calculated to be at least 50%, and as great as 75%, depending on the composition of the cementitious material used and the amount incorporated into the expanded honeycomb structure. This is of prime importance where structures must be built that have specific weight requirements that must be met. Even though the weight of the composite structure has been reduced significantly, the structural integrity and strength of the composite structure produced has not been compromised due to the physical attributes of the expanded honeycomb material.

Another important attribute of the present invention is the cost savings achieved by reducing the amount of cementitious material used in the structure. Since considerably less cementitious material is used in the final structure, the cost savings are significant. Also, the elimination or reduction of rebar or fibrous reinforcement materials used in the structure increases the cost savings realized.

Another noteworthy feature of the present invention is the ease of installation of the lighter weight composite structure produced. Since the structure is invariably lighter in weight, fewer personnel are required to install the structures and equipment used in the installation need not be as massive and expensive.

One skilled in the art can readily see the flexibility and adaptability of the unique composite structures of the present invention to an assortment of applications, such as roadways, floors, walls, ceilings, columns, ramps, concrete forms, and any other applications where reduction in weight, lower cost of materials, and ease of handling or installation would be advantageous.

The present invention having been thus described with particular reference to the preferred forms thereof, it will be obvious that various changes and modifications may be made therein without departing from the spirit and scope of the present invention as defined herein.

What is claimed is:

1. A method for producing a cementitious reinforced expanded honeycomb material, the method comprising:
contacting at least one side of the expanded honeycomb material with a semisolid or liquid cementitious material, wherein the cementitious material penetrates at least a first portion of the honeycomb material, thereby forming an integrated honeycomb/cementitious product;
vibrating the integrated honeycomb/cementitious product to remove air pockets therefrom and/or level the surface of the cementitious product which is opposite from the interface between the expanded honeycomb material and the cementitious material; and
curing the integrated honeycomb/cementitious product, thereby forming the cementitious reinforced expanded honeycomb material.

2. The method of claim 1, further comprising:
contacting a second surface of the expanded honeycomb product which is opposite to the surface of the expanded honeycomb cementitious reinforced expanded honeycomb material with a second semisolid or liquid cementitious material, wherein the cementitious material penetrates at least a the second surface of the expanded honeycomb material, thereby forming a integrated honeycomb product with first and second layers of cementitious material disposed on opposite surfaces thereof;
vibrating the integrated honeycomb product to remove air pockets therefrom and/or level the surface of the cementitious product which is disposed opposite the second portion of the expanded honeycomb material; and
curing the integrated honeycomb product with first and second layers of cementitious material disposed on opposite surfaces thereof, thereby forming a multilayer cementitious reinforced expanded honeycomb material.

3. The method of claim 1, wherein the thermoformable honeycomb comprises at least one material selected from the group consisting of: high impact polystyrene, polycarbonate, acrylonitrile butadiene styrene, homo- or co-polymer polypropylene, and low or high density polyethylene.

4. The method of claim 1, wherein the thermoformable honeycomb further comprises at least one additive selected from the group consisting of: plastic, glass, mineral, carbon, ceramic, boron, wood, aramid, or metal fibers, carbon nanotubes or nanoclays, calcium carbonate, calcium silicate, calcium sulfate, aluminum silicate, alumina trihydrate, glass microspheres, carbon black, solid/liquid or paste pigments, silicon dioxide, flexible polymeric materials such as butadiene, acrylonitrile, carboxyl terminated butadiene styrene, and recycled materials.

5. The method of claim 1, wherein the cementitious material comprises at least one additive selected from the group consisting of: plastic, glass, mineral, carbon, ceramic, boron, wood, aramid, or metal fibers, carbon nanotubes or nanoclays, calcium carbonate, calcium silicate, calcium sulfate, aluminum silicate, alumina trihydrate, glass microspheres, carbon black, solid/liquid or paste pigments, silicon dioxide, flexible polymeric materials such as butadiene, acrylonitrile, carboxyl terminated butadiene styrene, and recycled materials.
